(19) United States
(12) Patent Application Publication
(10) Pub. No.: US 2004/0136806 A1
(43) Pub. Date: Jul. 15, 2004

(54) Robust fastener locking device

(76) Inventors: Michael E. Montgomery, Niskayuna, NY (US); Michael T. Hamlin, Schoharie, NY (US); Thomas W. Swart, Niskayuna, NY (US); David R. Skinner, Pattersonville, NY (US); Daniel M. Popa, Schenectady, NY (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/341,081

(22) Filed: Jan. 13, 2003

(51) Int. Cl. F16B 39/10

(52) U.S. Cl. 411/122

(57) ABSTRACT

A robust fastener locking device (10, 20) prevents loosening of a fastener (F) used to attach to two parts (P1, P2) together. A plate (12, 22) fits against a part and abuts against at least two adjacent sides (S1, S2) of the part. The plate has an opening (14, 24) therein sized for a bolt to be inserted through the opening with the head of the bolt, or the nut (N) bearing against the plate when the fastener is secured in place. A portion of the plate adjacent the opening is deformable about the fastener after the fastener is secured in place to prevent subsequent rotation of the fastener which would loosen the fastener. In one embodiment, tabs (30a-30c) are formed adjacent the opening and can be bent about the portion of the fastener. The tab is broken off if the fastener needs to be removed, but the locking device can be reused.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to fasteners; and more particularly, to a device for securely locking two or more fasteners of the same type together.

It is well known that fasteners are used to join parts together. It is also well known that there are a wide variety of fasteners. These devices include lock washers, helical spring washers, castle or slotted nuts/keys, locknuts, and conventional locking plates, among others. Each of these types of fasteners differ in design, and in usage.

Lock washers, for example, have teeth which fit into grooves that are machined into surfaces of the parts being fastened together for the washer to better grip and hold the parts together. A disadvantage of lock washers is that if they become loose, there is no redundant restraint to limit the loosening of the washer, and it may ultimately fall away and with the result that the parts separate.

Helical spring washers rely on a spring force, due to the helical shape of the washers, to press parts together. As with lock washers, a fundamental disadvantage of spring washers is that if they become loose, there is no redundant restraint to stop their continued loosening and falling off the parts. Again this arrangement allows the parts to separate.

Castle, or slotted nuts, and their associated keys are constructed to prevent loosening of the fastener. However, if the nut does become loose due to shocks, vibrations, part movement, etc., there is, again, no redundant restraint to stop its continued loosening. In addition, if the key fails, there is also nothing to prevent the fastener from loosening.

When lock nut fasteners are used, the nut is typically deformed after it is in place to prevent loosening. However, if the nut breaks loose because of the vibrations, shocks, and other forces encountered during normal use of the parts, there is no redundant restraint to prevent the fastening from loosening and ultimately coming apart.

Peened fasteners are similar to lock nut fasteners in that the nut is deformed after the parts are connected together with the fastener. Now, deformation results from peening the surface of a part about the fastener after the fastener is in place. The plastic deformation of the material minimizes potential loosening of the nut and rotation of the fastener. Disadvantages with these fasteners is again lack of redundancy if the nut breaks loose, the amount of material which is deformed about the nut to secure the fastener in place, the fact that the material is permanently distorted.

Rather than peening, some fasteners are tack-welded to the fastened parts once the fastener is in place. Again, nothing prevents the fastener from loosening if the tack welding fails. Tack welding usually involves welding a large fastener to an equally large part with a relatively small weld. However, as with peening, normal usage will result in the fastener breaking apart over time and loosening.

Finally, in some applications, a locking plate is used with two or more fasteners to secure them in place. Conventional locking plates have the disadvantage that they tend to fail because of part fatigue resulting from the bending and flexing of the plate over time. Or, if a plate's design is not closely tailored to the particular application with which it is used, thermal strains are induced in the plate causing it to rupture or fracture. Once the plate fails, there is usually no backup to maintain the fasteners in their desired positions relative to each other.

In turbo-machinery, a common use of fasteners attaching two webs of material to each another using one or more of the fasteners, a combination of the fasteners, described above. All of the various types of fasteners used to connect parts of a turbo-machine together tend to loosen over time due to normal machine operation, and the consequences of this loosening can be severe. For example, pieces of a fastener will fall between the parts causing jams and damage to parts. The result is having to take the turbo-machinery out of service for repair which, in some circumstances, can cause power outages. Or, parts of the fastener may be propelled away from the machinery and damage other equipment or people. In either instance, a substantial safety hazard is created, and the costs of the resulting parts damage, machine down time, energy outages, and personal injuries, is significant.

In addition to the above, pieces of equipment are connected together for a reason. That is so they function in a reliable and intended manner. Accordingly, a loosened fastener, even if it does not fall off, results in the parts not being connected together as well as they could be and this loosened fastener effects the overall operation of the turbo-machinery.

The present invention addresses these problems by providing a robust fastener locking device having a redundancy capability which maintains attachment of parts together and reliable equipment functioning.

### BRIEF SUMMARY OF THE INVENTION

Briefly stated, the present invention comprises a robust fastener locking device formed from a material whose thermal expansion and similar mechanical properties are similar to those of the parts joined together by a fastener. When two parts are connected together, a separate locking device is used for both portions (bolt and nut) of the fastener. After the fastener is secured in place, a portion of each locking device is preferably deformed about the respective portions of the fastener. This approach substantially eliminates the probability of the fastener loosening by providing two separate constraints (one on each portion of the fastener) on rotation of the parts of the fastener.

In a second embodiment, the robust fastener locking device is capable of multiple uses so, for example, if a fasteners needs to be removed for any purpose, the locking devices can be reused when the same or new fasteners are used to attach the parts together again.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is plan view of a prior art fastener combination used to connect two parts together;

FIG. 2 is an elevation view of a pair of robust fastener locking devices of the present invention used with a conventional fastener to attach two parts together;

FIG. 3 is another side elevation view of one of the robust fastener locking devices used with the fastener;

FIG. 4 is a perspective view of the robust fastener locking device;

FIG. 5 is a bottom plan view of the robust fastener locking device showing tack welding of a base leg portion of the locking device to a part with which the locking device is used;

FIG. 6 is an elevation view of another embodiment of the robust fastener locking device capable of multiple uses; and,

FIG. 7 is a perspective view of the second embodiment.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

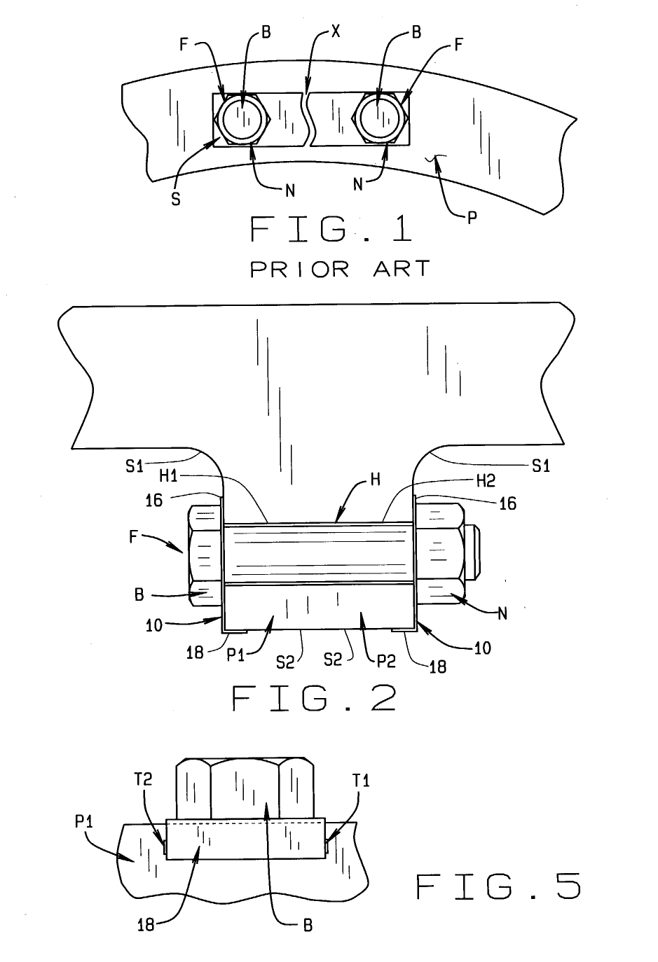

Referring to FIG. 1, as set forth in the Background portion of the Description, a fastener F such as the two fasteners shown in the drawing are used to join or attach to parts P together. In FIG. 1, the fasteners F are nut and bolt type fasteners having a bolt B whose threaded ended shank is captured by a nut N. In FIG. 1, a strap S extends between the bolt holes (not shown) in part P through which the bolts extend between the parts being connected together. The strap is used to help keep the fasteners in place and the nuts N from loosening from their associated bolts during operation of the equipment (turbo-machine) of which the parts form a part. However, as indicated by the line of rupture X, over time, vibrations, shocks, normal flexing and bending of the parts, and thermal expansion and contraction of the parts cause a fatigue failure of the strap. Once the strap fails, there is no redundant capability to prevent the nuts from loosening which they will do over time.

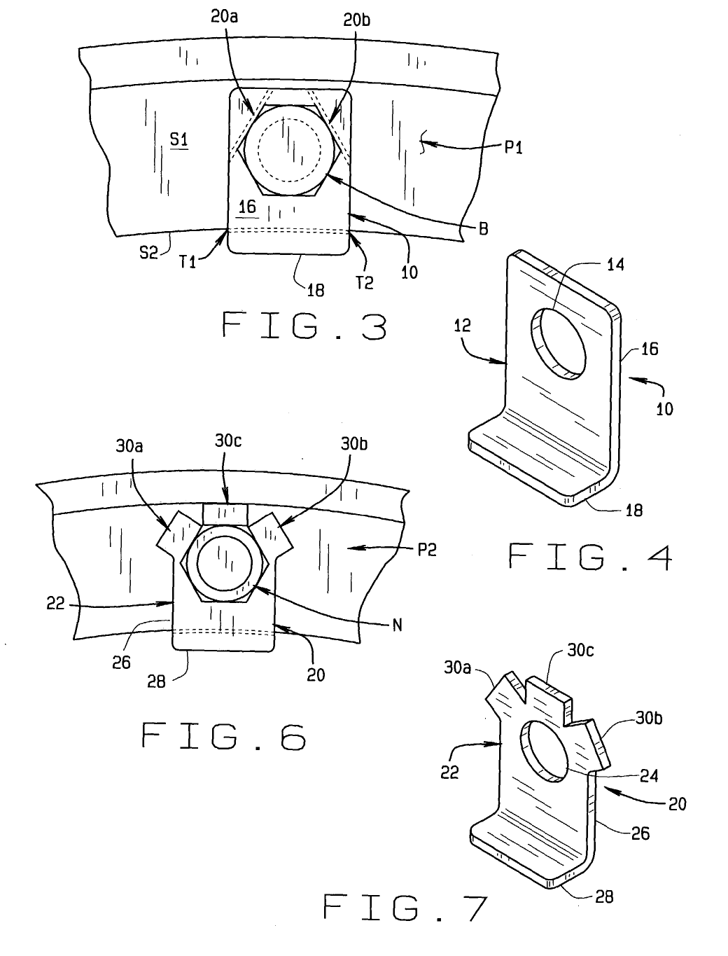

In accordance with the present invention, a robust fastener locking device is used to securely lock common fasteners such as the fasteners F in place. A first embodiment of the device is indicated generally 10 in FIG. 4. As shown in FIGS. 2 and 3, and as described herein, a pair of locking devices 10 is employed with a fastener F to prevent loosening or rotation of the fastener while equipment is in service. Use of a pair of devices with each fastener minimizes the potential for device failure due to low cycle fatigue or rupture due to thermal strain. Importantly, selection of the material from which the locking devices are constructed is based on the type of material from which the fastened parts are made.

Each robust fastener locking device 10 comprises a generally rectangular shaped plate 12 which is formed, as shown in FIG. 4, into a generally L-shape. In FIG. 2, a bolt hole H has sections H1, H2 which respectively extend through the sides of parts P1, P2 which are to be joined together using fastener F. When the parts are positioned so bolt holes H1, H2 align with each other, a bolt B of the fastener is inserted through the holes and a nut N is threaded onto the threaded end of the shank of the bolt. Before the bolt is inserted is inserted into hole H1, an L-shaped locking device 10 is abutted against a side S1 of part P1. A hole 14 is formed in a longer leg 16 of locking device 10, and the diameter of the hole corresponds to that of the bolt hole. The locking device is positioned so hole 14 aligns with bolt hole H1. The locking device is also formed so a shorter leg 18 of the device fits beneath part P1 and extends along an underside S2 of the part, as shown in FIG. 2, abutting against the underside. Thus, when the locking device is in place, it abuts against two adjacent sides of the part. This arrangement will prevent the locking device from readily be rotated or moved.

An identically formed locking device 10 is similarly placed against the side of part P2 with a hole 14 in leg 16 of the device aligned with bolt hole H2 in part P2 and with leg 18 of the device fitting beneath the underside of the part. Now, when bolt B is inserted through the bolt hole, and when nut N is in place, not only are parts P1 and P2 connected together, but the two plates 10 are locked in place to parts P1 and P2 Referring to FIG. 3, once the fastener is in place, a tool (not shown) can be used to bend a section of leg 16 of device 10 against the side of the head of bolt B and against nut N. As shown in FIGS. 2 and 3, the length of leg 16 of device 10 is such that the upper end of the leg extends above the location of the head of bolt B and nut N. In FIGS. 2 and 3, the bolt head and nut are each shown to be hexagonally shaped. As shown by the dashed lines in FIG. 3, an upper end 20a or 20b of leg 16 can be bent away from the side of the respective part P1 or P2, and pressed against one side of the bolt head or nut. This arrangement prevents rotation of the bolt head or nut so fastener F remains tightly in place.

Once the locking devices are positioned with respect to the bolt hole in the part, they can be secured against movement by tack welding the locking device, as indicated at T1 and T2, to the part. The tack weld is made along the base of the locking device; i.e., along leg 18 on the underside of the part. This arrangement is as shown in FIGS. 3 and 5. Because the tack welding now prevents the locking device from moving, any force applied to the locking device, which might otherwise cause the locking device to move and perhaps permit the bolt head or nut to rotate, will not result in such action occurring.

These features are important because they allow the robust fastener locking devices 10 to not only lock the fastener F in place, but to also provide two separate constraints on the fastener subsequently loosening. Since separate locking devices are employed for the bolt head and the nut, a constraint is separately provided by each locking device. Thus, even if something were to happen at one end of the fastener which might otherwise cause the nut or bolt to rotate and loosen, the robust fastener locking device 10 at the other end of the fastener acts to prevent the rotation and loosening of the fastener.

Since the separate locking devices 10 are in contact with only one of the parts attached together by fastener F, the potential for thermal strain of the devices is minimized. The potential for thermal strain is also minimized by matching the material from which the locking devices are fabricated with the material from which parts P1 and P2 are made. This approach may mean, for example, that if parts P1 and P2 are made of dissimilar materials, the material from the locking device 10 used with part P1 is made will differ from the material from which the locking device used with the part P2 is made.

Referring to FIGS. 6 and 7, a second embodiment of a robust fastener locking device of the present invention is indicated generally 20. Again, two of the locking devices are used with each fastener F. Each locking device 20 comprises a generally rectangular shaped plate 22 formed, as shown in FIG. 7, into a generally L-shape. As with the previously described embodiment, when parts P1, P2 are positioned so bolt holes H1, H2 align with each other, a bolt B of the fastener is inserted through the holes and a nut N is threaded onto the threaded end of the shank of the bolt. Again, before the bolt is inserted is inserted into hole H1, a locking device 20 is positioned against the side of part P1, and another locking device 20 against the side of part P2. A hole 24, formed in the longer leg 26 of each locking device 20, has a diameter corresponding to that of the bolt hole and the locking devices are positioned so the holes 24 align with the bolt hole. A leg 28 of each locking device fits beneath the respective parts and abuts against the underside of each part.

Each locking device 20 has three locking tabs 30a-30c formed at the upper end of leg 26 adjacent hole 24. One of the tabs projects outwardly from the respective sides of leg 26, and the third tab extends above the top of the leg. After the fastener is in place and nut N has been tightened on the bolt, a tool (not shown) is used to bend one of the tabs up against a side of the bolt head or nut to prevent its subsequent rotation. If the parts are subsequently disassembled, the tabs are simply broken off so the fastener can be removed. When the parts are reconnected, the locking devices is reused with another of the tabs being bent to lock the bolt head or nut in place to keep it from rotating. As with locking device 10, locking device 20 can be tack welded in place.

Those skilled in the art will understand that while the two locking devices 10 and 20 described above for use with a fastener F are identical in construction, they do not have to be. In particular, depending upon the geometry of each part P1, P2 about bolt hole, one of the locking devices may have a different shape from the other. Plate 12 or 22 of one locking device 10 or 20, for example, may be longer or shorter depending upon the distance from the bolt hole location in the respective part to the edge of the part over which the plate bends. Opening 14 in leg 16 of locking device 10 (or opening 24 in leg 26 of locking device 20) is shown formed so as to be completely surrounded by a web of material. The hole could be formed at the end of the plate and so not be completely surrounded by a web of material. What is important is that there be sufficient material about the opening that once the fastener is secured, a portion of leg 16 (or a tab 30) can be bent up and about the bolt head or nut to keep the bolt head or nut from subsequently rotating.

Further, it will be appreciated by those skilled in the art that the locking device can be attached to the part by other than welding. For example, leg 18 or 28 of the respective locking devices could be glued, pinned, screwed or otherwise secured to the side of the part.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A robust fastener locking device (10, 20) for preventing loosening of a fastener (F) used to attach two parts (P1, P2) together, comprising a plate (12, 22) fitting against the part and abutting against at least two adjacent sides (S1, S2) of the part, the fastener having a portion (B) inserted through a hole (H1, H2) in the parts to connect the parts together, the plate having an opening (14, 24) therein sized for the portion of the fastener inserted through the hole to fit through the opening, a portion of the plate adjacent the opening being deformable about the fastener, after the fastener is secured in place, to prevent subsequent rotation of the fastener which would loosen the fastener.

2. The robust fastener locking device of claim 1 further including two locking devices (10, 20) one of which is used with a portion (B) of the fastener (F) that extends between the two parts, and another of which is used with the portion (N) of the fastener that secures the fastener in place.

3. The robust fastener locking device of claim 2 in which the fastener comprise a nut and bolt and of the locking devices is used to lock the head (B) of the bolt in place and the other locking device is used to lock the nut (N) in place after the nut is threaded onto the bolt to secure the fastener in place.

4. The robust fastener locking device of claim 2 in which the plate of each locking device is bent with one leg portion (16, 26) of the locking device abutting against one side (S1) of the part, and another leg portion (18, 28) of the locking device abuts against the other side (S2) of the part.

5. The robust fastener locking device of claim 4 in which the opening is formed in one of the legs, the locking device is positioned against the one side of part so the opening aligns with the hole in the part, and the other leg, which abuts against the other side of the part, is attached to the other side of the part.

6. The robust fastener locking device of claim 5 in which the other leg of the locking device is secured to the other side of the part by welding, pinning, screwing, or gluing.

7. The robust fastener locking device of claim 6 wherein a plurality of tabs (30a-30c) are formed on the plate adjacent the opening for the locking device to be reusable with the fastener, one of the tabs being deformed about the fastener when the fastener is secured in place.

8. The robust fastener locking device of claim 7 in which the tab deformed about the fastener is broken off if the fastener is removed, and one of the remaining tabs is deformed about the fastener when the fastener is again secured in place.

9. The robust locking device of claim 1 in which the plate is formed of a material whose thermal and other physical characteristics are similar to those of the part with which the locking device is used so to reduce cyclic or eliminate? fatigue which can cause the locking device to fail.

10. A robust fastener locking device (10, 20) for preventing loosening of a fastener (F) used to attach two parts (P1, P2) together, the locking device comprising:
a generally L-shaped plate (12, 22) fitting against the part and having a first leg (16, 26) which abuts against one side (S1) of the part, and a second leg (18, 28) which abuts against a second side (S2) of the part;
the fastener having a portion (B) inserted through a hole (H1, H2) in the parts to connect the parts together and the plate having an opening (14, 24) formed in one of the legs (16, 26) and sized for the portion of the fastener inserted through the hole to fit through the opening; and,
a portion of the plate adjacent the opening being deformable about the fastener, after the fastener is secured in place, to prevent subsequent rotation of the fastener which would loosen the fastener.

11. The robust fastener locking device of claim 10 in which the fastener comprises a nut (N) and a bolt (B) and a separate locking device is used to lock the head of the bolt and the nut in place after the nut is threaded onto the bolt to secure the fastener in place.

12. The robust fastener locking device of claim 10 in which the leg (18, 28) of the device in which the opening (14, 24) is not formed is attached to the side (S2) of the part after the opening is aligned with the hole (H1) in the part.

13. The robust fastener locking device of claim 12 in which the other leg of the locking device is secured to the other side of the part by welding, pinning, screwing, or gluing.

14. The robust fastener locking device of claim 10 wherein a plurality of tabs (30a-30c) are formed on the leg (16, 26) of the plate (12, 22) adjacent the opening (14, 24) for the locking device to be reusable with the fastener, one of the tabs being deformed about the fastener when the fastener is secured in place.

15. The robust fastener locking device of claim 14 in which the tab deformed about the fastener is broken off if the fastener is removed, and one of the remaining tabs is deformed about the fastener when the fastener is again secured in place.

16. The robust locking device of claim 10 in which the plate is formed of a material whose thermal and other physical characteristics are similar to those of the part with which the locking device is used so to reduce cyclic or eliminate? fatigue which can cause the locking device to fail.

17. A robust fastener locking device (10, 20) for preventing loosening of a fastener (F) used to attach two parts (P1, P2) together, the locking device comprising:
a generally L-shaped plate (12, 22) fitting against the part and having a first leg (16, 26) which abuts against one side (S1) of the part, and a second leg (18, 28) which abuts against a second side (S2) of the part;
the fastener having a portion (B) inserted through a hole (H1, H2) in the parts to connect the parts together and the plate having an opening (14, 24) formed in one of the legs (16, 26) and sized for the portion of the fastener inserted through the hole to fit through the opening; and,
a plurality of tabs (30a-30c) are formed on the leg (16, 26) of the plate (12, 22) adjacent the opening (14, 24) for the locking device to be reusable with the fastener, one of the tabs being deformed about the fastener when the fastener is secured in place to prevent subsequent rotation of the fastener which would loosen the fastener.

18. The robust fastener locking device of claim 17 in which the fastener comprises a nut (N) and a bolt (B) and a separate locking device is used to lock the head of the bolt and the nut in place after the nut is threaded onto the bolt to secure the fastener in place.

19. The robust fastener locking device of claim 18 in which the leg (18, 28) of the device in which the opening (14, 24) is not formed is welded to the side (S2) of the part after the opening is aligned with the hole (H1) in the part.

20. The robust locking device of claim 18 in which the plate is formed of a material whose thermal and other physical characteristics are similar to those of the part with which the locking device is used so to reduce cycle fatigue which can cause the locking device to fail.
